(19) United States
(12) Patent Application Publication
(10) Pub. No.: US 2011/0298344 A1
(43) Pub. Date: Dec. 8, 2011

(54) Method of installing insert to reduce surface deflection

(76) Inventors: Charles J. Tyner, Savannah, GA (US); Henry E. Pritchett, Byron, GA (US)

(21) Appl. No.: 13/068,989

(22) Filed: May 25, 2011

Related U.S. Application Data
(60) Provisional application No. 61/396,753, filed on Jun. 2, 2010.

(51) Int. Cl. A47B 81/00; B32B 7/12; B32B 37/26

(52) U.S. Cl. 312/237; 156/289; 156/293; 156/91; 428/343

(57) ABSTRACT

The present invention provides for a method to install an insert to reduce surface deflection, the method comprising the steps of: apply a release agent to a receptacle in a panel, install an insert in the receptacle, and apply an adhesive around the insert in the receptacle. Where the insert bonds to the panel, and the release agent configured to substantially prevent a bond between the insert and at least one side of a surface in the panel. The release agent, configured to release the surface tension between the insert and the panel surface. In another preferred aspect, a flex agent bonds the insert to the panel, where the flex agent configured to releases the tension between the panel surface and the insert; and the flex agent provides support to the panel surface.

### CROSS-REFERENCE TO RELATED APPLICATIONS

This application claims priority to U.S. provisional patent application No. 61/396,753, filed Jun. 2, 2010, entitled “Method of installing insert to reduce surface deflection”.

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

Changing the composition of a panel by installing an insert allows one to use the panel in various ways. An insert, secured to a panel, becomes one with the panel, wherein the surface of the panel moves with the insert when a fastener is installed and torqued. This movement deforms the surface of the panel, giving the panel an undesirable appearance.

### BRIEF SUMMARY OF THE INVENTION

The present invention provides for a method to install an insert to reduce surface deflections, the method comprising the steps of, apply a release agent to a receptacle in a panel, install an insert in the receptacle, and apply an adhesive around the insert and the receptacle, where the insert bonds to the panel, and the release agent configured to substantially prevent a bond between the insert and at least one of the surfaces in the panel. In a preferred aspect of the present invention the release agent allows movement between the surface in the panel and the insert, providing a release of tension between the insert and the surface. In another preferred aspect, the release agent prevents the insert from adhering to at least one surface of the panel, and the release agent adheres to the panel and an inner body. In another preferred aspect of the present invention, a barrier blocks the adhesive, to prevent the adhesive from migrating past the release agent.

The present invention also provides for a cabinet system, comprising a top, a side, a back, a drawer, a door, an opening, a base, a seat, a light, a shelf, and a floor to form a cabinet, with respect to at least one of the top, the back, the drawer, the door, the opening, the base, the seat, the light, the shelf, and the floor, where the method to install an insert to reduce surface deflection is used in the cabinet system.

The present invention also provides for another method to install an insert to reduce surface deflection, the method comprising the steps of, open a receptacle in a panel, apply a flex agent to the receptacle, install an insert in the receptacle, and apply an adhesive around the insert, where the flex agent configured to flex and reduce surface deflection. In another aspect, the flex agent bonds the insert to the panel. In another preferred aspect, the flex agent combines with the release agent to inhibit the flex agent from adhering to at least one side of the insert. In another aspect, the flex agent covers at least one side of a surface in the panel, and the release agent substantially covers the flex agent on at least one side of the surface in the panel. In another preferred aspect of the present invention, the flex agent cover portions of at least one side of the surface in the panel, and the release agent cover the flex agent portions on at least one side of the surface in the panel.

The present invention also provides for another method to install an insert to reduce surface deflection, the method comprising the steps of, open a receptacle in a panel, apply at least one of a layer B to the receptacle, apply at least one of a layer A to the receptacle, install an insert in the panel, apply an adhesive around the insert, and install an activator fastener to activate at least one of the layer B, and layer A, where the layer B and layer A form a flexible bond with at least one of the insert and the surface in the panel. In another preferred aspect of the present invention, where the layer B and the layer A secured to adhere to at least one side of the surface in the panel

### BRIEF DESCRIPTION OF THE SEVERAL VIEWS OF THE DRAWING

FIG. 1 is a sectional view of preferred steps to install an insert;

FIG. 2 is a perspective view of an insert and a release agent;

FIG. 3 is a sectional view of another preferred steps to install an insert;

FIG. 4 is a perspective view of an insert, a release agent, and a barrier;

FIG. 5 is a sectional view of another preferred steps to install an insert;

FIG. 6 is a perspective view of an insert, and a flex agent;

FIG. 7 is a sectional view of an insert, and the flex agent around the insert;

FIG. 8 is a sectional view of another preferred steps to install an insert;

FIG. 9 is a perspective view of an insert, a release agent, and a flex agent;

FIG. 10 is an exploded view of an embodiment of a panel with a release agent;

FIG. 11 is a view of an assembled panel with a flex agent;

FIG. 11 A is another cross-section of FIG. 11 showing an insert installation;

FIG. 12 is an exploded view of an embodiment of a panel with a release agent, and a flex agent;

FIG. 13 is a view showing an insert installation;

FIG. 13A is another cross-section of FIG. 13 showing an insert installation;

FIG. 14 is an exploded view of another embodiment of a panel with a release agent;

FIG. 15 is a view of another exploded panel with a release agent, and a flex agent;

FIG. 16 is a cross-sectional view of another preferred steps to install an insert with at least one of an activator fastener, a layer A, and a layer B;

FIG. 17 is an exploded view of an insert with at least one of a layer A, and a layer B;

FIG. 18 is a view of a fastener activator and the flex agent;

FIG. 19 is a perspective view of a cabinet system;

FIG. 20 is an obverse perspective view of a cabinet system;

FIG. 21 is a view of an insert and a depth gauge; and

FIG. 22 is a view adding the present invention to a sheet material void of the present invention.

### DETAILED DESCRIPTION OF THE INVENTION

In the following description, the use of “a”, “an”, or “the” can refer to the plural. All examples given are for clarification only, and are not intended to limit the scope of the invention. When used in this specification, unless the context otherwise indicates—the term “side” means a side of a cabinet system.

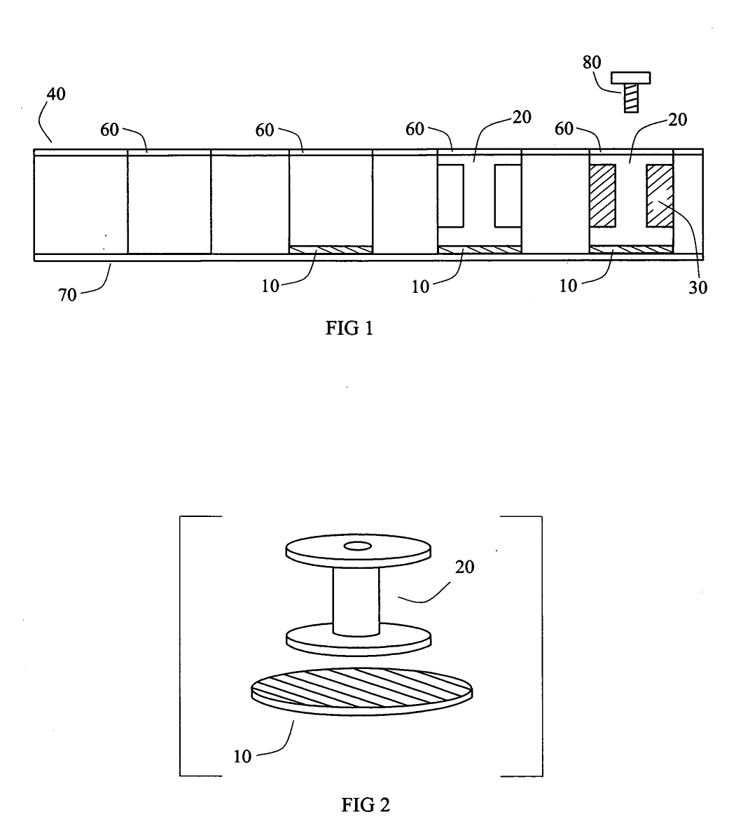

Referring now to FIGS. 1 and 2, a method of installing an insert to reduce surface deflection, comprising a release agent 10, an insert 20, an adhesive 30, a panel 40, a receptacle 60, a surface 70, and a fastener 80. Open the receptacle 60 in the panel 40, and apply the release agent 10 to the surface 70 through the receptacle 60. Install the insert 20 in the receptacle 60, and apply the adhesive 30 to secure the insert 20 in the receptacle 60 of the panel 40. The adhesive 30 bonds the insert 20 to the panel 40, apply tension to the insert 20 with the fastener 80, and the release agent 10, configured to release the insert 20, from the panel 40 at the release agent 10 application area, inside the receptacle 60 at the surface 70, wherein preventing tension buildup at the surface 70 in the panel 40. The insert 20 and the adhesive 30, configured to bond with the panel 40, and the release agent 10 configured to substantially prevent a bond between the insert 20 and at least one of the surface 70 of the panel 40. The release agent 10, configured to allow movement between the insert 20, and the surface 70 in the panel 40. Install and tighten the fastener 80, configured to apply tension to the insert 20, wherein the release agent 10, configured to release the insert 20 from the panel 40 at the release agent 10 application area, inside the receptacle 60 at the surface 70 in the panel 40. Wherein the fastener 80, configured to apply and release tension on the insert 20, and the majority of the time reduce deflection at the surface 70.

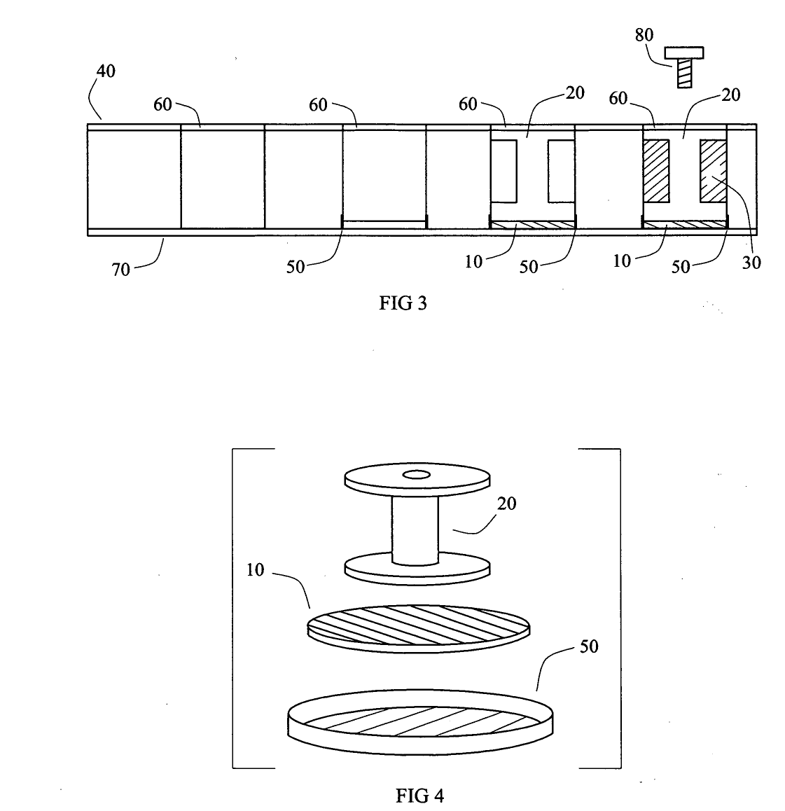

Referring now to FIGS. 3 and 4, another method of installing an insert to reduce surface deflection, comprising the release agent 10, the insert 20, the adhesive 30, the panel 40, a barrier 50, the receptacle 60, and the surface 70. Open the receptacle 60 in the panel 40, apply the release agent 10 to at least one side of the barrier 50, position the barrier 50 and the insert 20 in the receptacle 60. Apply the adhesive 30 to secure the insert 20 in the receptacle 60 of the panel 40. The adhesive 30 bonds the insert 20 to the panel 40. Install and tighten the fastener 80 configured to apply tension to the insert 20, wherein the release agent 10 configured to release tension at the insert 20, from the panel 40 at the release agent 10 application area; inside the receptacle 60 at the surface 70 in the panel 40. The barrier 50, configured to further inhibit a bond between the adhesive 30 and the surface 70. Wherein the barrier 50, configured to substantially block the adhesive 30 and prevent tension buildup at the surface 70 in the panel 40. The barrier 50 could lay flat on the surface 70, or the barrier 50 could also be on the walls of the receptacle 60.

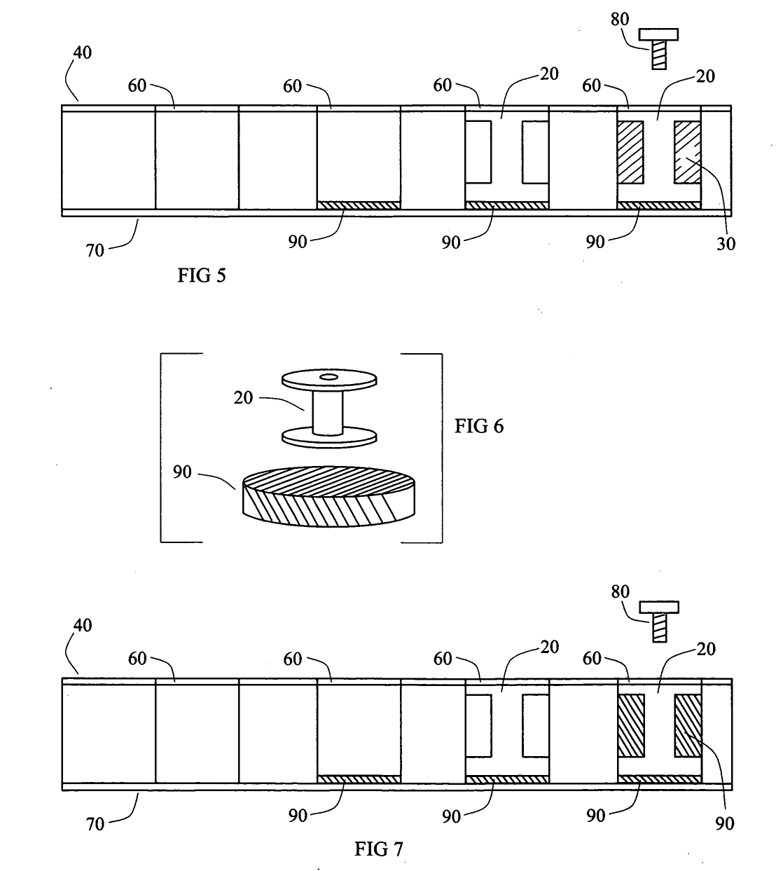

Referring to FIGS. 5 and 6, another preferred method of installing an insert to reduce surface deflection, comprising the insert 20, the adhesive 30, the panel 40, the receptacle 60, the surface 70, the fastener 80, and a flex agent 90. Open the receptacle 60 in the panel 40, apply the flex agent 90 to at least one side of the surface 70, and install the insert 20 in the receptacle 60. Apply the adhesive 30 to secure the insert 20 in the receptacle 60 of the panel 40. The adhesive 30 bonds the insert 20 to the panel 40. Install and tighten the fastener 80, configured to apply tension to the insert 20, wherein the flex agent 90, configured to flex and allow the insert 20 to move and substantially release tension from the panel 40 at the flex agent 90 application area, inside the receptacle 60 at the surface 70 in the panel 40. The flex agent 90, configured to bond the insert 20 and the surface 70. Wherein the flex agent 90, configured to expand and contract under pressure from the fastener 80, and under changing atmospheric conditions, to prevent tension buildup at the surface 70 in the panel 40.

Referring to FIG. 7, another preferred method of installing an insert to reduce surface deflection, comprising the insert 20, the panel 40, the receptacle 60, the surface 70, the fastener 80, and the flex agent 90. Open the receptacle 60 in the panel 40, and install the insert 20 in the receptacle 60. Apply the flex agent 90 to secure the insert 20 in the receptacle 60 of the panel 40. The flex agent 90 bonds the insert 20 to the panel 40. Install and tighten the fastener 80 configured to apply tension to the insert 20, wherein the flex agent 90, configured to flex and allow the insert 20 to move and substantially release tension from the panel 40 at the flex agent 90 application area, inside the receptacle 60 at the surface 70 in the panel 40. The flex agent 90, configured to bond the insert 20 and the surface 70. Wherein the flex agent 90, configured to expand and contract under pressure from the fastener 80, and under changing atmospheric conditions, to prevent tension buildup at the surface 70 in the panel 40.

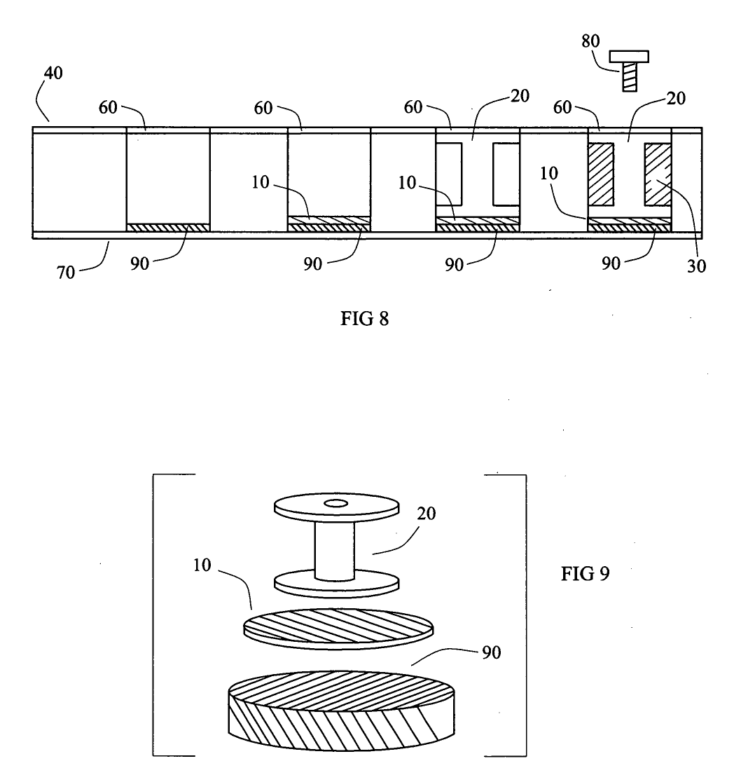

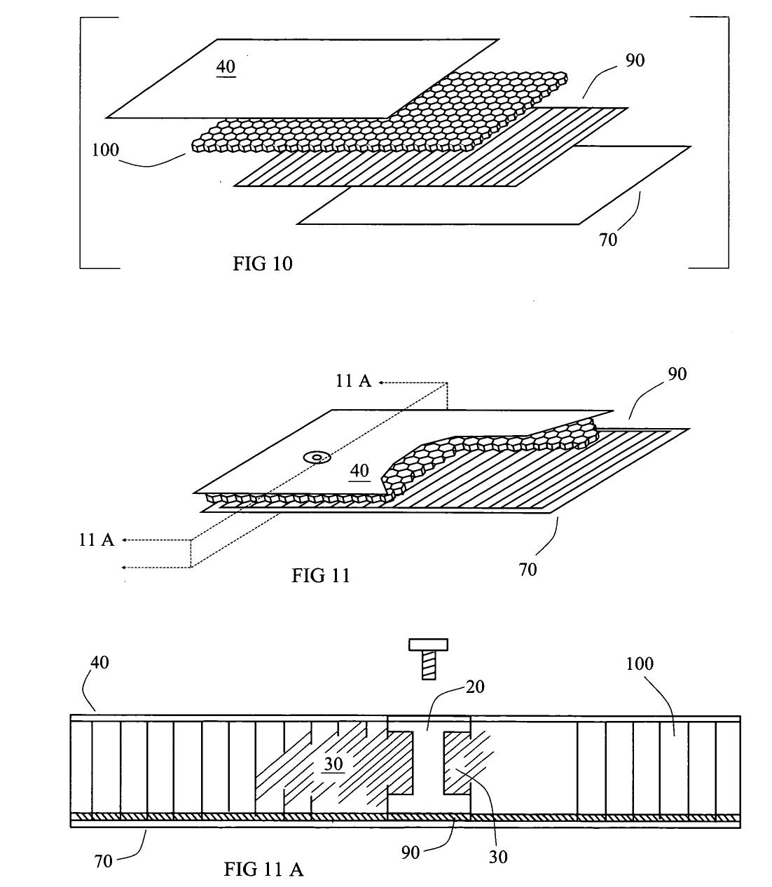

Referring now to FIGS. 8 and 9, another aspect of a method of installing an insert to reduce surface deflection, comprising the release agent 10, the insert 20, the adhesive 30, the panel 40, the receptacle 60, the surface 70, the fastener 80, and the flex agent 90. Open the receptacle 60 in the panel 40, apply the flex agent 90 to at least one side of the surface 70, apply the release agent 10 to at least one side of the flex agent 90, and install the insert 20 in the receptacle 60. Apply the adhesive 30 to secure the insert 20 in the receptacle 60 of the panel 40. The adhesive 30 bonds the insert 20 to the panel 40. Install and tighten the fastener 80, configured to apply tension to the insert 20, wherein the flex agent 90, configured to flex and support the surface 70 around the insert 20, and the release agent 10 configured to substantially release tension from the panel 40 at the flex agent 90 application area, inside the receptacle 60. The flex agent 90, configured to bond and provide support to the surface 70, wherein the flex agent 90, configured to expand and contract under pressure from the fastener 80, and under changing atmospheric conditions, to prevent tension buildup at the surface 70 in the panel 40. The release agent 10, configured to release tension between the insert 20 and the flex agent 90, under excessive pressure to reduce surface deflection, and the flex agent 90 configured to provide support to the surface 70.

Referring to FIGS. 10, 11 and 11 A, another preferred method of installing insert to reduce surface deflection, comprising the insert 20, the adhesive 30, the panel 40, the surface 70, the flex agent 90, and an inner body 100. The flex agent 90, configured to substantially cover at least one side of the surface 70. The flex agent 90, further configured to bond with the inner body 100 and the surface 70. Wherein the flex agent 90, configured to embed into the inner body 100 to inhibit the adhesive 30 from bonding to the surface 70, past the insert 20 installation site. The panel 40, configured to be assembled according to the practices known to those in the art. Install the insert 20 in the panel 40, apply the adhesive 30 around the insert 20, wherein the adhesive 30, configured to bond the insert 20 with the inner body 100 and the panel 40. The insert 20 and the flex agent 90, configured to allow the insert 20 to flex in the panel 40 and reduce the surface 70 deflection.

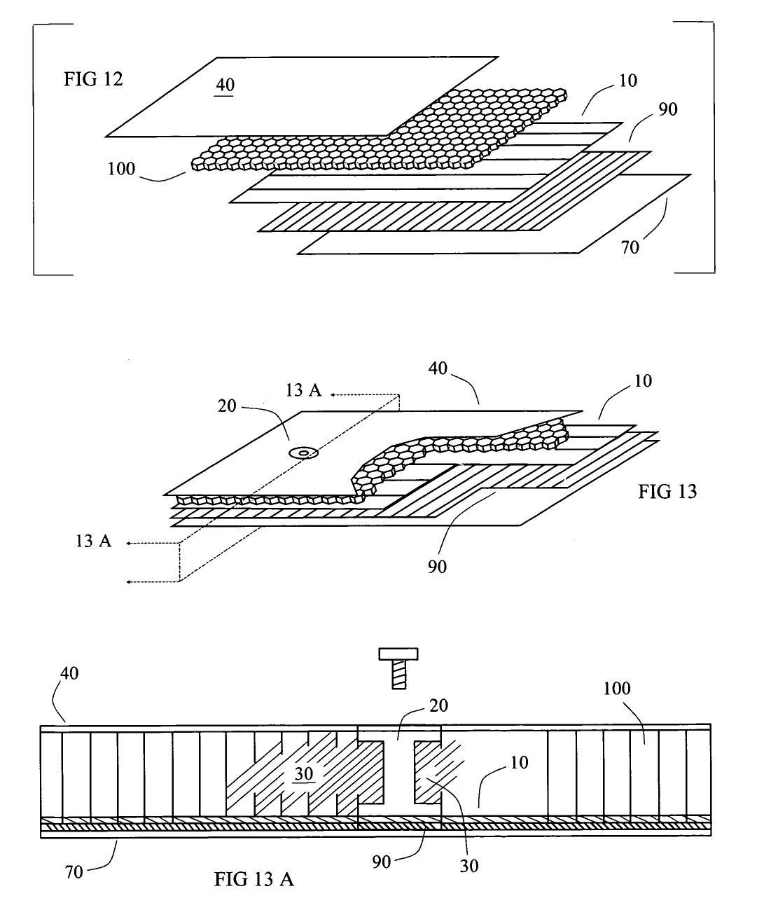

Referring to FIGS. 12, 13 and 13A, another preferred method of installing insert to reduce surface deflection, comprising the release agent 10, the insert 20, the adhesive 30, the panel 40, the surface 70, the flex agent 90, and the inner body 100. The flex agent 90, configured to substantially cover at least one side of the surface 70. The flex agent 90, further configured to bond with the inner body 100 and the surface 70. Wherein the flex agent 90, configured to embed into the inner body 100 to inhibit the adhesive 30 from bonding to the surface 70, past the insert 20 installation site. The release agent 10, configured to substantially cover the flex agent 90, wherein the release agent 10, configured to embed into the inner body 100, and the inner body 100 bonds to the flex agent 90. Assemble the panel 40 according to the practices known to those in the art. Install the insert 20 in the panel 40, apply the adhesive 30 around the insert 20, wherein the adhesive 30, configured to bond the insert 20 with the inner body 100 and the panel 40. The insert 20 and the flex agent 90, configured to allow the insert 20 to flex in the panel 40 and reduce the surface 70 deflection. The release agent 10, configured to release tension between the insert 20 and the flex agent 90, under excessive pressure to reduce the surface 70 deflection, and the flex agent 90 configured to provide support to the surface 70.

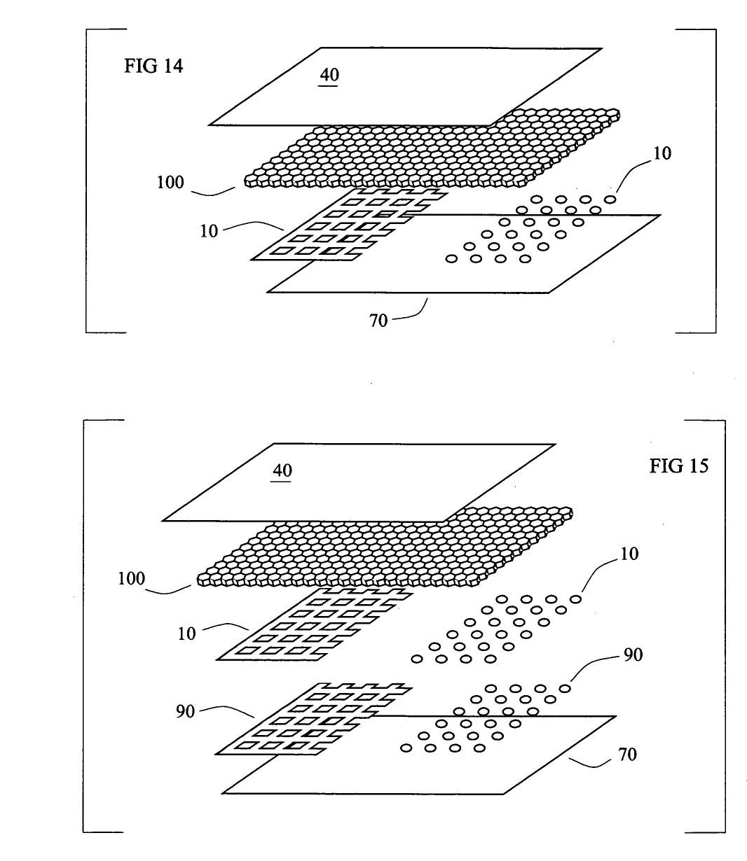

Referring to FIG. 14, another preferred embodiment of the present invention, comprising the panel 40, the surface 70, the flex agent 90, and the inner body 100. The flex agent 90, configured to partially cover at least one side of the surface 70. The flex agent 90, further configured to bond with the inner body 100 and the surface 70. Wherein the flex agent 90, configured to embed into the inner body 100 to inhibit the adhesive 30 from bonding to the surface 70, past the insert 20 installation site. Assemble the panel 40 according to the practices known to those in the art. Referring to FIG. 11A, install the insert 20 in the panel 40, apply the adhesive 30 around the insert 20, wherein the adhesive 30, configured to bond the insert 20 with the inner body 100 and the panel 40. The insert 20 and the flex agent 90, configured to allow the insert 20 to flex in the panel 40 and reduce the surface 70 deflection, wherein the flex agent 90 configured to provide support to the surface 70. The flex agent 90, could be applied in strips to at least one of the surface 70, and the flex agent 90 could be applied in spots to at least one of the surface 70.

Referring to FIG. 15, another preferred embodiment of the present invention, comprising the release agent 10, the panel 40, the surface 70, the flex agent 90, and the inner body 100. The flex agent 90, configured to partially cover at least one side of the surface 70. The flex agent 90, further configured to bond with the inner body 100 and the surface 70. Wherein the flex agent 90, configured to embed into the inner body 100 to inhibit the adhesive 30 from bonding to the surface 70, past the insert 20 installation site. The release agent 10, configured to substantially cover the flex agent 90, wherein the release agent 10, configured to embed into the inner body 100, and the inner body 100 bonds to the flex agent 90. Assemble the panel 40 according to the practices known to those in the art. Referring to FIG. 13A, install the insert 20 in the panel 40, apply the adhesive 30 around the insert 20, wherein the adhesive 30, configured to bond the insert 20 with the inner body 100 and the panel 40. The insert 20 and the flex agent 90, configured to allow the insert 20 to flex in the panel 40 and reduce the surface 70 deflection. The release agent 10, configured to release tension between the insert 20 and the flex agent 90, under excessive pressure to reduce the surface 70 deflection, and the flex agent 90 configured to provide support to the surface 70. The release agent 10, and the flex agent 90, could be applied in strips to at least one of the surface 70, and the release agent 10, and the flex agent 90 could be applied in spots to at least one of the surface 70. These example are for clarification only and are not intended to limit the scope of the invention.

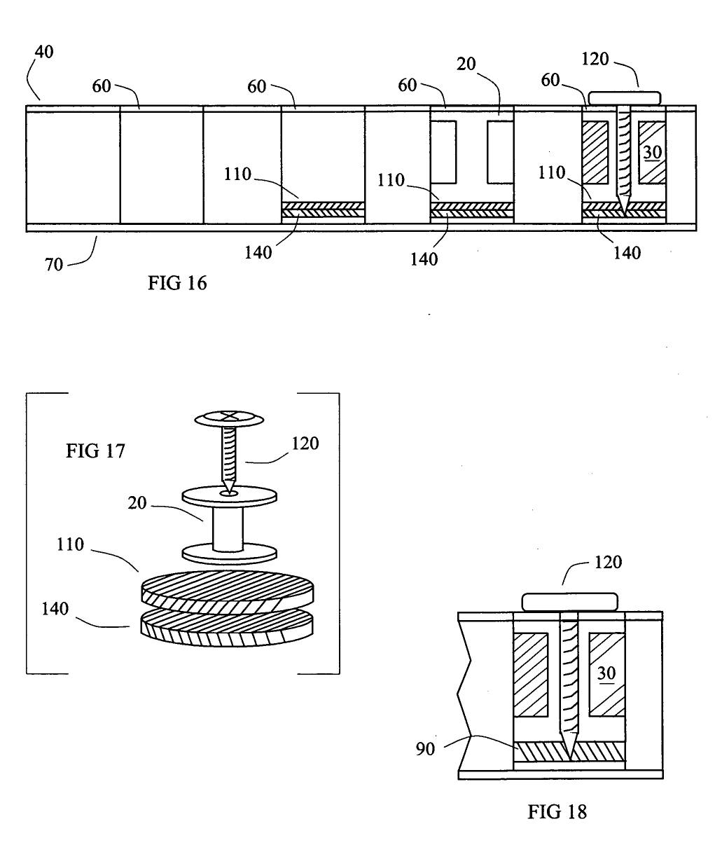

Referring now to FIGS. 16, 17, and 18, another preferred method of installing insert to reduce the surface 70 deflection. A method comprising of: open the receptacle 60 in the panel 40, apply at least one of a layer B 140 to the receptacle 60, and over the layer B 140, apply at least one of a layer A 110 to the receptacle 60, and install the insert 20 in the receptacle 60 of the panel 40, apply the adhesive 30 around the insert 20, to bond the insert 20 to the panel 40. An activator fastener 120, configured to act as the fastener 80, as shown in FIG. 1, and to act as the activator of the layer B 140, and the layer A 110, and combine the layer B 140 and the layer A 110, to form the flex agent 90. Install the activator fastener 120 in the insert 20 to activate at least one of the layer B 140, and at least one of the layer A 110, wherein at least one of the layer B 140, and at least one of the layer A 110, configured to form the flex agent 90 in FIG. 18, and adhere to at least one of the insert 20 and at least one of the surface 70 in the panel 40. The insert 20 and the flex agent 90, configured to allow the insert 20 to flex in the panel 40 and reduce the surface 70 deflection, wherein the flex agent 90 configured to provide support to the surface 70. Not shown in this FIG., the Layer B 140 and the layer A 110 could be secured to the receptacle 60 at the surface 70 with the adhesive 30, also a separate partition may be inserted at the surface 70 inside the receptacle 60 to provide additional support to the surface 70. It will be apparent to one skilled in the art that the insert 20 need not be touching the surface 70—it could be shorter and configured to apply at least one of a layer B 140 to the receptacle 60, and over the layer B 140, apply at least one of a layer .A 110 to the receptacle 60, to accommodate various lengths of the insert 20.

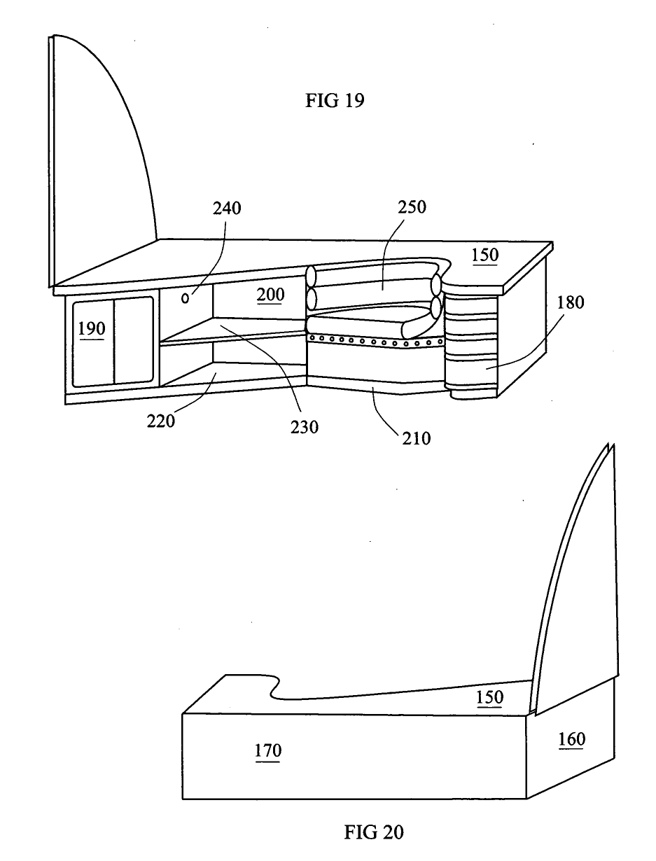

Referring now to FIGS. 19, and 20, another preferred embodiment of the present invention, a cabinet system comprises a top 150, a side 160, a back 170, a drawer 180, a door 190, an opening 200, a base 210, a floor 220, a shelf 230, a light 240, and a seat 250, with respect to at least one of the top 150, the side 160, the back 170, the drawer 180, the door 190, the opening 200, the base 210, the floor 220, the shelf 230, the light 240, and the seat 250, and the method of installing insert to reduce the surface 70 deflection, to form the cabinet system. The cabinet system could comprise of a bed, a couch, a galley, a lavatory, and a table. These example are for clarification only and are not intended to limit the scope of the invention.

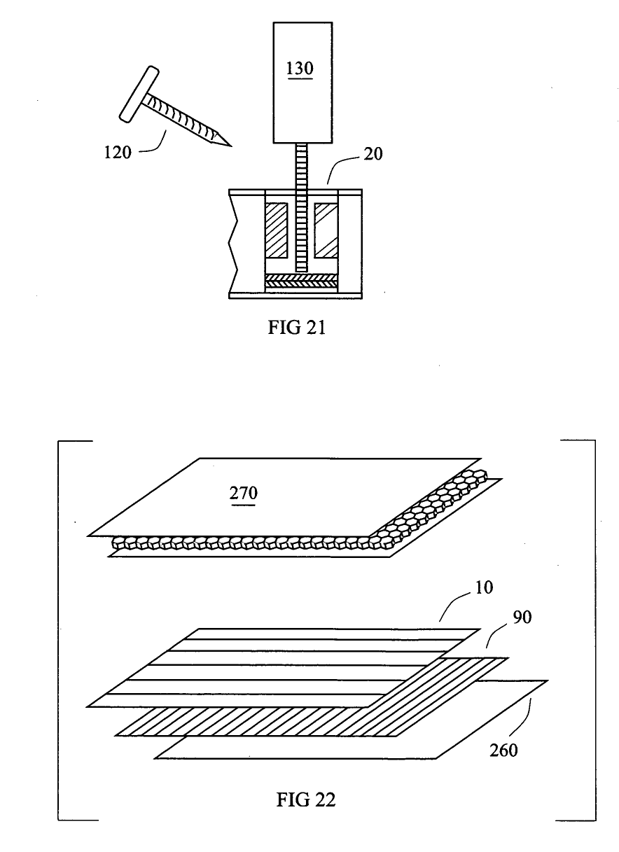

Referring to FIG. 21, a depth gauge 130, configured to estimate the length of the activator fastener 120. Wherein the depth gauge 130 configured to measure the inside depth of the insert 20, and estimate the total length of the activator fastener 120. The depth gauge 130, configured with incremental lines, and estimated lengths beside the incremental lines, running the length of the depth gauge 130. The depth gauge 130, configured to obtain the proper length of the activator fastener 120, to insure proper activation of the layer B 140 and the layer A 110, as shown in FIG. 16.

A Sheet material 270, as shown in FIG. 22, and void of embodiments of the present invention, could be configured with a veneer 260, and apply at least one of the flex agent 90, and the release agent 10, and install the insert 20, as shown in FIGS. 11A, and 13A. In this aspect of the present invention, the majority of the sheet material 270, void of the present invention could substantially convert to the present invention.

We claim:

1. A method to install an insert to reduce surface deflection, the method comprising the steps of:
apply a release agent to a receptacle in a panel:
install an insert in the receptacle; and
apply an adhesive around the insert in the receptacle;
Wherein the insert bonds to the panel, and the release agent configured to substantially prevent a bond between the insert and at least one of a surface in the panel.

2. The release agent as claimed in claim 1, wherein the release agent configured to allow movement between the surface in the panel and the insert, to provide a release of tension between the insert and the surface.

3. The release agent as claimed in claim 1, wherein the release agent substantially prevents the insert from adhering to at least one side of the surface in the panel, and the release agent substantially adheres to the panel and an inner body.

4. A cabinet system, comprising:
a top;
a side;
a back;
a drawer;
a door;
an opening;
a base;
a seat;
a light;
a shelf; and
a floor to form a cabinet, with respect to at least one of the top, the side, the back, the drawer, the door, the opening, the base, the seat, the light, the shelf, and the floor, and a method to install an insert as claimed in claim 1.

5. The release agent as claimed in claim 1, wherein a barrier configured to substantially reduce the adhesive from bypassing the release agent.

6. A method to install an insert to reduce surface deflection, the method comprising the steps of:
open a receptacle in a panel;
apply a flex agent to the receptacle;
install an insert in the receptacle; and
apply an adhesive around the insert;
wherein the flex agent configured to flex and substantially reduce surface deflection.

7. The flex agent as claimed in claim 6, wherein the flex agent configured to bond the insert to the panel.

8. The flex agent as claimed in claim 6, further comprising a release agent to substantially inhibit the flex agent from adhering to at least one side of the insert.

9. The flex agent as claimed in claim 6, wherein the flex agent substantially covers at least one side of a surface.

10. The flex agent as claimed in claim 6, wherein a release agent substantially covers the flex agent on at least one side of a surface.

11. The flex agent as claimed in claim 6, wherein the flex agent configured to cover portions of at least one side of the surface.

12. The flex agent as claimed in claim 11, wherein the release agent configured to cover the flex agent portions.

13. A method to install an insert to reduce surface deflection, the method comprising the steps of:
open a receptacle in a panel;
apply at least one of a layer B to the receptacle;
apply at least one of a layer A to the receptacle;
install an insert in the panel;
apply an adhesive around the insert; and
install an activator fastener to activate at least one of the layer B, and the layer A;
wherein the layer B and the layer A, configured to form the flex agent, and adhere with at least one of the insert, and the surface.

14. The layer B and the layer A as claimed in claim 13, wherein at least one of the layer B, and the layer A adhere to at least one side of the surface.
